(19) United States
(12) Patent Application Publication
(10) Pub. No.: US 2013/0021440 A1
(43) Pub. Date: Jan. 24, 2013

(54) DATA CODEC METHOD AND DEVICE FOR THREE DIMENSIONAL BROADCASTING

(71) Applicants: Byeongho Choi, Yongin-si (KR); Yong-Hwan Kim, Anyang-si (KR); Jewoo Kim, Seongnam-si (KR); Hwa Seon Shin, Seongnam-si (KR)

(72) Inventors: Byeongho Choi, Yongin-si (KR); Yong-Hwan Kim, Anyang-si (KR); Jewoo Kim, Seongnam-si (KR); Hwa Seon Shin, Seongnam-si (KR)

(73) Assignee: KOREA ELECTRONICS TECHNOLOGY INSTITUTE, Seongnam-si, Gyeonggi-do (KR)

(21) Appl. No.: 13/638,869

(22) PCT Filed: Nov. 26, 2010
(86) PCT No.: PCT/KR10/08463

§ 371 Date: Oct. 1, 2012

(30) Foreign Application Priority Data
Apr. 2, 2010 (KR) 10-2010-0030559

(51) Int. Cl. H04N 13/00; H04N 13/04

(52) U.S. Cl. 348/43; 348/42; 348/51; 348/E13.072; 348/E13.075

(57) ABSTRACT

Disclosed are a data modulation method and a data modulation system for 3D broadcasting, and more particularly, are a method and a system for maintaining a conventional 2D broadcasting service while providing a 3D broadcasting service. A 3D broadcasting service method includes generating a data frame including existence or nonexistence of 3D data, a header including information on codec types of a left image and a right image, a right image stream, and a left image stream, and transmitting the generated data frame.

### TECHNICAL FIELD

The present invention relates to a data modulation method and a data reception apparatus for 3D broadcasting, and more particularly to a method and an apparatus for maintaining a 2D broadcasting service while providing a 3D broadcasting service.

### BACKGROUND ART OF THE INVENTION

After selecting an Advanced Television Systems Committee (ATSC) standard of North America corresponding to an 8-VSB mode as a terrestrial digital broadcasting mode on November, 1997, Korea has developed associated core technologies and has performed a field test and test broadcasting. In Korea, conventional analog broadcasting and digital broadcasting have been broadcasted at the same time after 2001, but all broadcasting will be completely switched to the digital broadcasting in 2012.

An ATSC refers to a committee, which develops a digital television broadcasting standard of U.S.A, or the standard. The standard of the ATSC is determined as a current national standard in U.S.A, Canada, Mexico, and Korea, and due to be a standard in other countries including several countries of South America. The standards of the digital broadcasting include DVB developed in Europe, ISDB developed in Japan and the like as well as the ATSC.

According to the ATSC digital broadcasting standard which can transmit high quality video, voice and ancillary data, in terrestrial broadcasting, a terrestrial broadcasting channel of 6 MHz can transmit data at a data transmission rate of 19.39 Mbps, and a cable TV channel can transmit data at a data transmission rate of 38 Mbps. A video compression technology used in an ATSC method uses an ISO/IEC 13818-2 MPEG-2 video standard and uses MPEG-2 MP@HL, that is, Main Profile and High Level standard as a compression format, and defines an associated video format and restrictions.

Types of data transmitted in the conventional data broadcasting include control data such as a video compression stream, an audio compression stream, Program Specific Information (PSI), Program and System Information Protocol (PSIP) and the like, and ancillary data for the data broadcasting. An available data rate for the above listed data is a total of 19.39 Mbps. In the available data rate, the video compression stream uses 17 to 18 Mbps, an audio bit stream uses about 600 Kbps, a data broadcasting stream uses about 500 Kbps, and an EPG (including PSIP and the like) stream uses about 500 Kbps. Accordingly, a stereoscopic 3D video bit stream necessarily should have a bandwidth of 17 to 18 Mbps.

Since all broadcasting systems necessarily should guarantee backward compatibility so as to allow conventional subscribers to watch 2D broadcasting, the broadcasting system has restrictions that a right image must also be carried in the conventional bandwidth.

### DETAILED DESCRIPTION OF THE INVENTION

### Technical Problems

The present invention has been made to solve the above mentioned problems and provides a solution in which 3D broadcasting is received and watched simultaneously while conventional 2D broadcasting is watched in a broadcasting system (satellite, terrestrial, cable, and IP TV and the like) which is currently serviced.

The present invention provides a solution of basically improving image codec performance to service full high definition 3D broadcasting.

The present invention provides a solution of performing 2D and 3D broadcasting services at a minimum change in the broadcasting system and a minimum cost.

### Technical Solutions

In accordance with an aspect of the present invention, there is provided a three dimensional (3D) broadcasting service apparatus for generating a data frame, the data frame including: a header part including an identifier for indicating whether there exist 3D data; and one or more data streams of a right image data stream and a left image data stream.

In accordance with another aspect of the present invention, there is provided a 3D broadcasting receiving method including: checking an identifier included in a header part of received broadcasting data, the identifier indicating whether there exists 3D data; and when the identifier indicates that there exists the 3D data, separating a left image and a right image from the broadcasting data.

In accordance with still another aspect of the present invention, there is provided a 3D broadcasting receiving apparatus including: a broadcasting receiver for outputting demodulated data generated by demodulating received broadcasting data; a demultiplexer for outputting at least one data of right image data and left image data from the output demodulated data; a right image processor for decoding and outputting the right image data, the right image processor including a right image decoder; and a left image processor for decoding and outputting the left image data, the left image processor including a left image decoder.

In accordance with yet another aspect of the present invention, there is provided a 3D broadcasting transmitting apparatus including: a right image encoder for encoding a right image and outputting a right image stream; a left image encoder for encoding a left image and outputting a left image stream; and a multiplexer for generating a data frame by using existence or nonexistence of 3D data, a header including information on codec types of the left image and the right image, the right image stream output from the right image encoder, and the left image steam output from the left image encoder.

### Effects of the Invention

The present invention provides a method in which 3D broadcasting is received and watched simultaneously while conventional 2D broadcasting is watched in a broadcasting system (satellite, terrestrial, cable, and IP TV and the like) which is currently serviced. That is, according to the present invention, 2D and 3D broadcasting services are available at a minimum change in the broadcasting system and a minimum cost.

According to the present invention, a left image uses a compression scheme having the compression efficiency of 15%, and a right image uses a compression scheme having the compression efficiency of 30%, so that bandwidths for transmitting the left image and the right image may be secured and full high definition 3D broadcasting may be serviced using the secured bandwidths.

### BRIEF DESCRIPTION OF THE DRAWINGS

FIG. 1 is a view illustrating a structure of a broadcasting data frame for a 3D broadcasting service according to an embodiment of the present invention.

FIG. 2 is a block diagram illustrating a structure of a transmission side for a 3D broadcasting service according to an embodiment of the present invention.

FIG. 3 is a block diagram illustrating a structure of a reception side for a 3D broadcasting service according to an embodiment of the present invention.

FIG. 4 is a flowchart illustrating an operation of a reception side for performing a 3D broadcasting service according to an embodiment of the present invention.

<Description of Reference Numerals in Drawings>

| | |
|---|---|
| 200: right image encoder | 202: left image encoder |
| 204: audio encoder | 206: multiplexer |
| 300: broadcasting receiver | 302: demultiplexer |
| 306: voice processor | 308: right image processor |
| 310: left image processor | |

### MODE FOR CARRYING OUT THE INVENTION

The above and other aspects of the present invention will be more apparent through exemplary embodiments described with reference to the accompanying drawings. Hereinafter, the present invention will be described in detail through the embodiments of the present invention so that those skilled in the art can easily understand and implement the present invention.

The present invention proposes a solution of servicing a high quality 3D image while maintaining conventional 2D broadcasting and backward compatibility through a video coding mode and an analysis of a new coding algorithm.

FIG. 1 is a view illustrating a structure of a data transmission frame of a transmission side for providing a high quality 3D image according to an embodiment of the present invention. Hereinafter, the structure of the data transmission frame of the transmission side for providing the high quality 3D image according to the embodiment of the present invention will described in detail with reference to FIG. 1.

Referring to FIG. 1, the data transmission frame includes a header part, a left image stream part, a right image stream part, an audio stream part, an EPG part, a data broadcasting part, and null. Of course, it is apparent that the data transmission frame may further include other data as well as the above listed data.

The header unit includes existence or nonexistence of 3D image data, codec types of a left image and a right image, resolution information of the left image and the right image, a bit size of the left image and a bit size of the right image, identifiers of the left image and the right image, disparity information of the left image and the right image, and human factor related information of the left image and the right image.

Additionally describing the header part, the header part includes an identifier indicating whether there is 3D data, the codec types of the left image and the right image, data amounts for the left image, the right image, and the audio stream, and resolution of the left image and the right image. However, when the codec type, the data amounts, and the resolution of the left image are predetermined, corresponding information may not be included in the header part according to a setting. When the codec type, the data amounts, and the resolution of the right image are also predetermined, corresponding information may not be included in the header part according to a setting. In this case, information on the identifier indicating whether there is the 3D data is included in the header part.

The left image stream part transmits a video stream associated with the left image at a transmission rate of 12 to 14 Mbps, and the right image stream part transmits a video steam associated with the right image at a transmission rate of 4 to 6 Mbps. That is, the left image stream part transmits the left image, and the right image stream part transmits the right image. The reception side can output a 3D image by receiving and reproducing all of the left image stream and the right image stream.

With respect to the present invention, an encoding method according to a video quality of the image stream transmitting the left image steam and the right image stream is proposed.

A first plan suggests a method of transmitting a full HD 3D image stream. To this end, the left image stream is encoded into an MPEG-2 main profile and then transmitted, and the right image stream is encoded into an MPEG-4 AVC/H.264 high profile and then transmitted. Through the above described method, the left image stream transmits the image stream at a transmission rate of 13 Mbps and with a resolution of 1080i@60 Hz, and the right image stream transmits the image stream at a transmission rate of 5 Mbps and with a resolution of 1080i@60 Hz. That is, the method of transmitting the full HD 3D image stream has advantages in that an optimal 3D video quality may be expected since resolution of the right image is the same as resolution of the left image, and the 2D broadcasting may be serviced by a conventional receiver without deterioration of the video quality since the resolution of the left image corresponding to a basic image is the same as the resolution of the conventional 2D broadcasting.

A second plan suggests a method of transmitting a High Definition (HD) 3D image stream. To this end, the left image stream is encoded into an MPEG-2 main profile and then transmitted, and the right image stream is encoded into an MPEG-4 AVC/H.264 high profile and then transmitted. Through the above described encoding method, the left image stream transmits the image stream at a transmission rate of 13 Mbps and with resolution of 1080i@60 Hz, and the right image stream transmits the image stream at a transmission rate of 5 Mbps and with resolution of 720p@60 Hz. That is, the method of transmitting the high definition 3D image stream has advantages in that the 2D broadcasting may be watched by a conventional receiver without deterioration of the video quality since the resolution of the left image corresponding to a basic image is the same as the resolution of the conventional 2D broadcasting.

A third plan suggests a method of transmitting a Standard Definition (SD) 3D image stream. To this end, the left image stream is encoded into an MPEG-2 main profile and then transmitted, and the right image stream is encoded into an MPEG-4 AVC/H.264 high profile and then transmitted. Through the above described encoding method, the left image stream transmits the image stream at a transmission rate of 13 Mbps and with resolution of 720p@60 Hz, and the right image stream transmits the image stream at a transmission rate of 5 Mbps and with resolution of 720p@60 Hz. That is, the method of transmitting the standard definition 3D image stream has advantages in that the method may be implemented by both a conventional MPEG-2 encoder and MPEG-4 AVC/H.264 encoder.

The audio stream part is an area in which audio data for broadcasting is transmitted, and an EPG is an area in which broadcasting related information is transmitted.

In an additional description, according to the first plan, a current encoding technique should secure 14 Mbps and 7 Mbps with respect to the left and right images for the high definition broadcasting, respectively, and thus encoding performance of the MPEG-2 and the MPEG-4 AVC/H.264 should be maximally improved. To this end, in the first plan, the left image is required to be improved by about 15% and compression efficiency of the right image is required to be improved by about 30% by using a high efficiency compression technique such as a High-performance Video Coding (HVC) in comparison with the MPEG-4 AVC/H.264. Through the above described high efficiency compression technique, the left image secures a bandwidth of about 12.5 Mbps and the right image secures a bandwidth of about 4.5 Mbps, so that the full high definition 3D broadcasting becomes possible.

Further, also in the second and third plans, a 3D image in a full-HD level may be serviced by applying an up-converting technique having excellent performance.

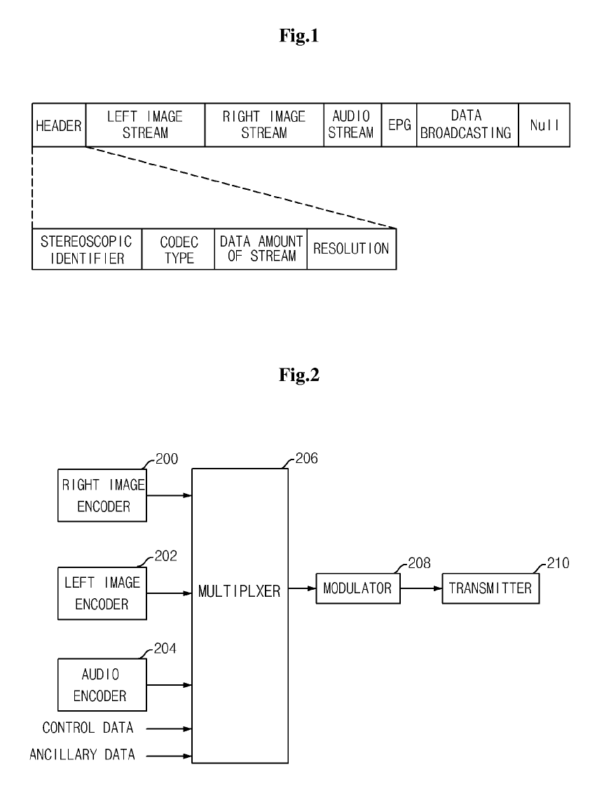

FIG. 2 is a block diagram illustrating a structure of a transmission side according to an embodiment of the present invention. Hereinafter, structure of the transmission side according to the embodiment of the present invention will be described in detail with reference to FIG. 2.

Referring to FIG. 2, the transmission side includes a right image encoder 200, a left image encoder 202, an audio encoder 204, a multiplexer 206, a modulator 208, and a transmitter 210. Of course, it is apparent that the transmission side may further include other components as well as the above listed components.

The left image encoder 202 encodes an input image by the reception side to reproduce a left image, and uses the MPEG-2 encoder. That is, the left image encoder 202 receives an image signal, encodes the image signal by using an MPEG-2 compression algorithm, and then transmits the image signal to the multiplexer 206.

The right image encoder 200 encodes an input image by the reception side to reproduce a 3D image, and uses the MPEG-4 encoder. That is, the right image encoder 200 receives an image signal, encodes the image signal by using an MPEG-4 compression algorithm, and then transmits the image signal to the multiplexer 206.

The audio encoder 204 receives a voice signal, encodes the voice signal by using a voice signal compression algorithm, and then transmits the voice signal to the multiplexer 206.

The multiplexer 206 multiplexes the image signals encoded by the right image encoder 200 and the left image encoder 202, the voice signal encoded by the audio encoder 204, control data, and ancillary data to generate a transmission stream.

The control data includes Program Specific Information (PSI), a Program and System Information Protocol (PSIP) and the like. The PSI includes a total of four tables, such as a Program Association Table (PAT), a Program Map Table (PMT), a Network Information Table (NIT), and a Conditional Access Table (CAT), and the PSIP includes a System Time Table (STT), a Master Guide Table (MGT), a Virtual Channel Table (VCT), a Rating Region Table (RRT), an Event Information Table (EIT), and an Extended Text Table (ETT). The ancillary data includes information for data broadcasting.

The modulator 208 modulates and outputs the transmission stream generated by the multiplexer 206. At this time, a modulation method is determined according to a digital broadcasting method, and an 8-Vestigial Side Band (VSB) modulation method is used in an Advanced Television System Committee (ATSC) mode. The transmitter 210 transmits the transmission stream output from the modulator 208 to an outside through a specific frequency band.

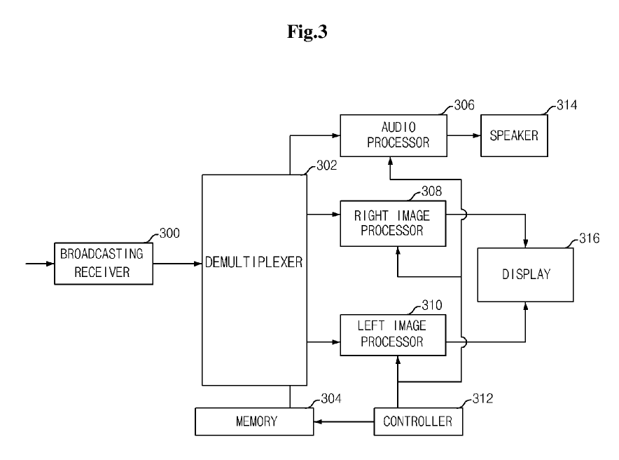

FIG. 3 is a block diagram illustrating a structure of a reception side according to an embodiment of the present invention. Hereinafter, the structure of the reception side according to the embodiment of the present invention will be described in detail with reference to FIG. 3.

Referring to FIG. 3, the reception side includes a broadcasting receiver 300, a demultiplexer 302, a voice processor 306, a right image processor 308, a left image processor 310, a memory 304, a controller 312, a speaker 314, a display 316 and the like. Of course, it is apparent that the reception side may include other components as well as the above listed components.

The broadcasting receiver 300 includes a tuner and a demodulator, and receives a broadcasting signal selected by a user among broadcasting signals input through an antenna or a cable to output a transmission stream. The broadcasting receiver 300 acquires a synchronization with a channel selected by the user, and then a demodulator outputs the transmission stream from the broadcasting signal through a demodulation process.

The demultiplexer 302 performs a demultiplexing by which the transmission stream output from the broadcasting receiver 300 is divided into an audio stream, a right image stream, and a left image stream.

The memory 304 stores the control data and the ancillary data divided by the demultiplexer 302 in a corresponding area for each broadcasting program.

The voice processor 306 includes an audio decoder, and decodes the audio stream divided by the demultiplexer 302 into a voice signal. The speaker 314 outputs the voice signal decoded by the voice processor 306 to an outside.

The right image processor 308 includes a right image decoder, and decodes the right image stream divided by the demultiplexer 302 to output the decoded right image stream as a right image signal. The left image processor 310 includes a left image decoder, and decodes the left image stream divided by the demultiplexer 302 to output the decoded left image stream as a left image signal. The display 316 displays the signal output by the right image processor 308 and the signal output by the left image processor 310 on a screen.

The controller 312 controls the voice processor 306, the right image processor 308, and the left image processor 310, and allows corresponding processors to process input voice and image. Further, the controller 312 transmits a control command to each device included in the reception side to allow each device to perform a corresponding operation.

In an additional description, when it is determined that there is no right image data by reading information indicating whether there is the right image data, the reception side decodes a received image according to a conventional 2D method. When there is the right image data, the reception side reads information on a codec type of the right image and the left image, and decodes a received left image steam by the left image decoder and a received right image stream by the right image decode.

The reception side can distinguish the right image and the left image by using information on an image data amount of the left image, or distinguish left image data and right image data by using an identifier added to a last part of the left image. Further, the reception side up-converts the left image and the right image by using information on resolutions of the left image and the right image as necessary so that the images can be reproduced in the display.

When the reception side selects only one image from the decoded left image and right image and reproduces the selected image, a conventional broadcasting terminal can surely provide the 2D image.

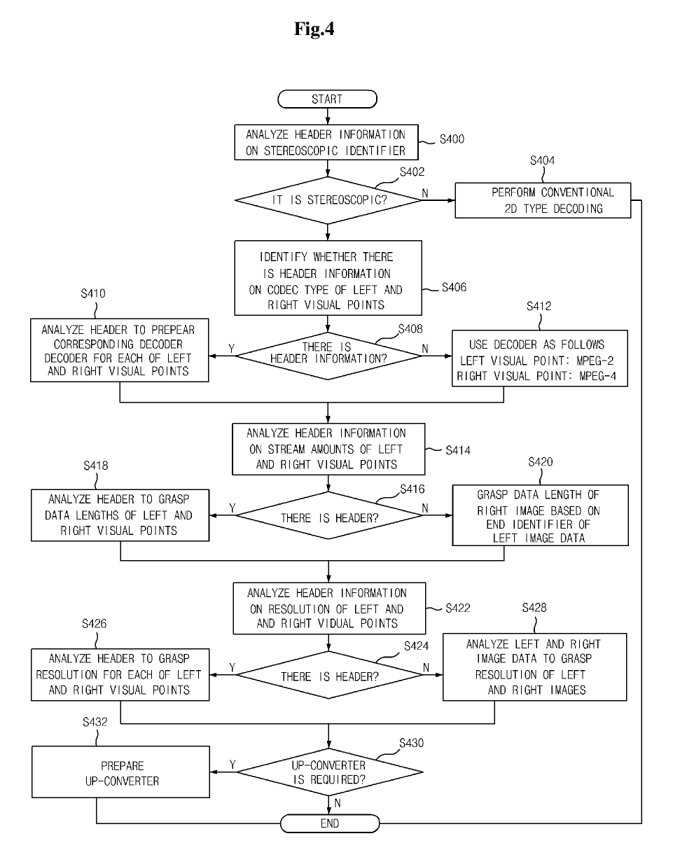

FIG. 4 is a flowchart illustrating an operation performed by a broadcasting reception side which can selectively receive 2D broadcasting and 3D broadcasting according to an embodiment of the present invention. Hereinafter, the operation performed by the broadcasting reception side which can selectively receive the 2D broadcasting and 3D broadcasting according to the embodiment of the present invention will be described in detail with reference to FIG. 4.

As described above, since the left image follows the conventional broadcasting, a separate image data type may be omitted, and the right image defined by the standard may also omit header information. Of course, it is apparent that the right image may follow a conventional 2D broadcasting standard, and the left image may be used as data for 3D broadcasting.

In step S400, the reception side analyzes a stereoscopic identifier included in the header part. In step S402, the reception side determines whether the received broadcasting is the 2D broadcasting or the 3D broadcasting by using the analyzed identifier. Then the reception side performs step S404 when the received broadcasting is the 2D broadcasting, and performs step S406 when the received broadcasting is the 3D broadcasting.

The reception side performs a decoding process for the received broadcasting according to a conventional 2D broadcasting decoding method in step S404.

The reception side checks whether there is information on codec types of the left image and the right image included in the header part in step S406. The reception side performs step S410 when there is the information on the codec types of the left image and the right image in the header part in step S408, and performs step S412 when there is no information on the codec types of the left image and the right image.

When there is no information on the codec types of the left image and the right image, the reception side uses conventionally set codec information of the left image and the right image in step S412. The present invention may adopt, but not limited to, the MPEG-2 as the decoder for the left image and the MPEG-4 as the decoder for the right image. In step S410, the reception side prepares the decoder for the left image included in the header part and the decoder for the right image.

The reception side checks whether there is information on data amounts of the left image and the right image included in the header part in step S414. The reception side performs step S418 when there is the information on the data amounts of the left image and the right image in the header part in step S416, and performs step S420 when there is no information on the data amounts of the left image and the right image.

In step S420, the reception side identifies a length of right image data by using an end identifier of left image data. In step S418, the reception side identifies lengths of the left image data and the right image data by analyzing the header part.

The reception side checks whether there is information on resolutions of the left image and the right image included in the header part in step S422. The reception side performs step S426 when there is the information on the resolutions of the left image and the right image in the header part in step S424, and performs step S428 when there is no information on the resolutions of the left image and the right image.

In step S428, the reception side identifies the resolutions of the left image and the right image by analyzing the left and right image data. In step S426, the reception side identifies the resolutions of the left image and the right image by analyzing the header part to grasp.

In step S430, the reception side determines whether an up-converter is required. The reception side performs step S432 when the up-converter is required, and prepares the up-converter.

The present invention may adopt, but not limited to, the MPEG-2 as the decoder for the left image and the MPEG-4 as the decoder for the right image.

Hereinafter, a method of improving left image encoder performance and a method of improving right image encoder performance will be described. First, the method of improving the left image encoder performance will be described.

The MPEG-2 video compression efficiency may be improved by Motion Estimation (ME), a bit rate control (Rate Control: RC), a Group Of Picture (GOP) control, a picture level encoding method and the like. Particularly, MPEG-2 encoding equipment is implemented in hardware, and may include a technology capable of further improving the compression efficiency in comparison with convention MPEG-2 encoding equipment due to a rapid development of a hardware technology. For example, in the bit rate control, a Rate-Distortion Optimization (RDO) algorithm is one of optimum technologies capable of improving the compression efficiency, but requires large amounts of operations, so that the RDO algorithm was not applied to the encoder in the past. However, due to the recent technology development, the RDO algorithm is included within an MPEG-2 encoder SoC and improves the compression efficiency.

In addition, it may be expected to improve the compression efficiency by about 10 to 15% in comparison with the conventional art through an adaptive control of a GOP size according to contents, the adaptive encoding application between frame/field picture structures, the adaptive application of a search range in a motion estimation and the like.

Hereinafter, the method of improving the right image encoder performance will be described. As described above, for the full HD 3D transmission of the first plan, the compression efficiency higher than MPEG-4 AVC/H.264 is required. As an alterative, Key Technology Area (KTA) software having higher performance than the MPEG-4 AVC/H.264 or High-performance Video Coding (HVC) which is recently started to be standardized is used. First, the KTA will be described.

Even after the MPEG-4 AVCOH.264 has been standardized, an ITU-T Video Coding Expert Group (VCEG) has made an effort steadily to improve the video coding performance after H.264. The improvement in a video technology by the VCEG is being achieved through the KTA even today.

The KTA includes considerable various element technologies since the KTA has not been researched for a single standard. The existence of the various element technologies included in the KTA is evidence that an encoding technology having the compression efficiency higher than the MPEG-4 AVC/H.264 may be expected, and shows the possibility that the 3D broadcasting may be provided in insufficient terrestrial broadcasting bandwidths. Representative algorithms applied up to now to the KTA are classified into respective fields as shown in Table 1.

TABLE 1

| | |
|---|---|
| Motion vector | Macroblock Extension (MBex) |
| encoding | Motion Vector Competition (MVC) |
| Intra prediction | Bi-directional Intra Prediction (BIP) |
| encoding | Mode Dependant Directional Transform |
| | (MDDT) |
| Adaptive interpolation | Non-Separable Adaptive Interpolation Filter |
| filter for motion | Directional Interpolation Filter (DIF) |
| prediction/ | Switched Interpolation Filter with Offset (SIFO) |
| compensation in | Separable Adaptive Interpolation Filter |
| the unit of real | Adaptive Interpolation with Directional Filters |
| number pixels | (DAIF) |
| | Enhanced Adaptive Interpolation Filter (EAIF) |
| | Enhanced Directional Adaptive Interpolation |
| | Filter (EDAIF) |
| In-loop post filter | Quadtree-based adaptive loop filter (QALF) |
| Quantization | Rate Distortion Optimized Quantization |
| | (RDOQ) |
| | Adaptive Quantization Matrix Selection |
| | (AQMS) |

There are technologies which can obtain higher encoding efficiency by simultaneously applying new algorithms applied to the KTA (for example, motion vector encoding schemes, intra prediction encoding scheme, and encoder schemes may be simultaneously used), and also there is a technology which selects one scheme from the applied various algorithms and uses the selected one scheme (for example, an adaptive interpolation filter can use only one of a lot of technologies).

Among algorithms proposed to the KTA having the higher compression efficiency than the conventional MPEG-4 AVC/H.264, there are many algorithms related to motion information and algorithms related to the interpolation for the motion information. It is evidence that the compression efficiency may be further improved by more accurate motion information. In general, the motion information is expressed in a vector type, expressed by using Motion Vector Predictor (MVP) which is a predicted value of a motion vector induced by the encoder and the decoder in the same way, and a Motion Vector Difference (MVD) which is a difference between a Motion vector (MV) corresponding to a vector value indicating a position of a reference image most similar to a current macroblock and the predicted value. Accordingly, many researches on a scheme using an accurate MVP value to minimize an MVD value for an accurate motion vector and an interpolation for finding a motion vector having high accuracy have been performed.

The MVC is a technology in which the encoder selects an optimum MVP from a plurality of MVPs which can be used as candidates through a rate-distortion cost function and minimizes an MVD value, and it is reported that the encoding efficiency has been improved by about 6% when selectively using MVP from two MVP candidates.

In the intra prediction encoding scheme, a bi-directional intra prediction scheme is introduced extended from a conventional intra prediction encoding scheme using 8 directivity, and in this case, the encoding efficiency may be improved by about 8% by simultaneously using a KLT-based directional transform.

The adaptive interpolation filter for motion prediction/compensation in the unit of real number pixels included in the KTA may be largely divided into a two-dimensional filter and one-dimensional separation type filter. A two-dimensional filter interpolation to find a more accurate motion vector has excellent performance, but has a disadvantage in that an operation for the filter is complex. In order to compensate for the disadvantage, a lot of one-dimensional separation type filters having the similar performance to that of the two-dimensional filter are proposed.

In-loop filter technologies refer to technologies for improving the visual video quality and the encoding efficiency, and may be achieved by using additional information (Post-filter Hint SEI) which can transmit a filter coefficient adopted by JVT-U035 as a standard. The QALP can selectively use the filter in the unit of blocks and is expected to improve the performance of about 7%.

A quantization scheme applied to the KTA includes RDO-Q which can improve the performance only through an encoder technology not influencing a decoder, and AQMS which adaptively uses a quantization matrix defined in the encoder and the decoder in the unit of blocks. The RDO-Q may improve the encoding performance by about 6% by calculating rounding-up/rounding-down for a transform coefficient through the rate-distortion cost function for each pixel.

A performance comparison between the algorithms applied to the KTA is as shown in Table 2. Table 2 describes performance between JM and KTA in two GOP structures, and is expected to improve the performance by 22%.

TABLE 2

| Use RDO-Q, MMDT, MBex, MVC, | | |
|---|---|---|
| EIAF, QALF | IPPP | Hierarchical B |
| CIF Average | −11.85% | −11.14% |
| WQVGA Average | −16.48% | −17.23% |
| WVGA Average | −20.91% | −24.44% |
| 720 Average | −31.59% | −31.03% |
| 1080P Average | −23.66% | −24.41% |
| Overall Average | −22.20% | −22.86% |

The High-performance Vide Coding (HVC) is a video codec which is standardized by a Joint Collaboration Team (JCT) corresponding to a third community of the MPEG and the VCEG. The HVC is expected to improve the performance by at least about 20% in comparison with MPEG-4 AVC/H.264.

While the present invention has been described with reference to the exemplary embodiments illustrated in the drawings, it is merely for an illustrative description and it will be understood by those skilled in the art that various changes in form and details may be made therein without departing from the spirit and scope of the invention as defined by the appended claims.

1. A three dimensional (3D) broadcasting service apparatus for generating a data frame comprising:
a header part including an identifier for indicating whether there exist 3D data; and
one or more data streams of a right image data stream and a left image data stream.

2. The 3D broadcasting service apparatus as claimed in claim 1, wherein the data frame further comprises at least one of resolution information of a left image and a right image, bit information of the left image and the right image, identifiers of the left image and the right image, video quality information of the left image and the right image, disparity information of the left image and the right image, and human factor information of the left image and the right image.

3. The 3D broadcasting service apparatus as claimed in claim 1, wherein the left image is compressed by MPEG-2, and the right image is compressed by MPEG-4 AVC/H.264.

4. The 3D broadcasting service apparatus as claimed in claim 1, wherein a bandwidth of the left image ranges from 12 to 14 Mbps, a resolution of the left image is one of 1080i@60 Hz and 720p@60 Hz, a bandwidth of the right image ranges from 4 to 6 Mbps, and a resolution of the right image is one of 1080i@60 Hz and 720P@60 Hz.

5. A three dimensional (3D) broadcasting receiving method comprising:
checking an identifier included in a header part of received broadcasting data, the identifier indicating whether there exists 3D data; and
when the identifier indicates that there exists the 3D data, separating a left image and a right image from the broadcasting data.

6. A three dimensional (3D) broadcasting receiving apparatus lo comprising:
a broadcasting receiver for outputting demodulated data generated by demodulating received broadcasting data;
a demultiplexer for outputting at least one data of right image data and left image data from the output demodulated data;
a right image processor for decoding and outputting the right image data, the right image processor including a right image decoder; and
a left image processor for decoding and outputting the left image data, the left image processor including a left image decoder.

7. The 3D broadcasting receiving apparatus as claimed in claim 6, further comprising:
a display for receiving the image data output from the right image processor or the left image processor.

8. The 3D broadcasting receiving apparatus as claimed in claim 6, further comprising:
a memory for storing control data and ancillary data output from the demultiplexer in a corresponding area for each broadcasting program.

9. A three dimensional (3D) broadcasting transmitting apparatus comprising:
a right image encoder for encoding a right image and outputting a right image stream;
a left image encoder for encoding a left image and outputting a left image stream; and
a multiplexer for generating a data frame by using existence or nonexistence of 3D data, a header including information on codec types of the left image and the right image, the right image stream output from the right image encoder, and the left image steam output from the left image encoder.
